(19) United States
(12) Patent Application Publication
(10) Pub. No.: US 2009/0252207 A1
(43) Pub. Date: Oct. 8, 2009

(54) METHODS AND APPARATUS TO TEST A CENTRAL OFFICE DIGITAL SUBSCRIBER LINE MODEM

(76) Inventors: Ronald Brost, Danville, CA (US); Goangshiuan Shawn Ying, Oakland, CA (US); Stephen M. Aspell, Brentwood, CA (US); Eugene L. Edmon, Danville, CA (US)

Correspondence Address: AT&T Legal Department - HFZ;ATTN. Patent Docketing, One AT&T Way, Room 2A-207, Bedminstor, NJ, 07921, US

(21) Appl. No.: 12/062,056

(22) Filed: Apr. 3, 2008

(51) Int. Cl. H04L 5/16; H04B 3/46

(52) U.S. Cl. 375/222; 375/224

(57) ABSTRACT

Methods and apparatus to test a central office (CO) digital subscriber line (DSL) modem are disclosed. An example line termination module for a DSL access multiplexer (DSLAM) comprises a printed circuit board, a plurality of DSL terminal unit-central (DTU-C) modems implemented on the printed circuit board, a DSL terminal unit-remote (DTU-R) modem implemented on the printed circuit board to test the DTU-C modems, and a switch implemented on the printed circuit board to selectively couple the DTU-R modem to a tested one of the DTU-C modems or to a subscriber line.

### FIELD OF THE DISCLOSURE

This disclosure relates generally to digital subscriber line (DSL) systems and, more particularly, to methods and apparatus to test a central office (CO) DSL modem.

### BACKGROUND

Communication systems using digital subscriber line (DSL) technologies are commonly utilized to provide Internet related services to subscribers, such as, homes and/or businesses (also referred to herein collectively and/or individually as users, customers and/or customer-premises). DSL technologies enable customers to utilize telephone lines (e.g., ordinary twisted-pair copper telephone lines used to provide Plain Old Telephone System (POTS) services) to connect to, for example, a high data-rate broadband Internet network, broadband service and/or broadband content. For example, a communication company and/or service provider may utilize a plurality of modems (e.g., a plurality of DSL modems) implemented by a DSL Access Multiplexer (DSLAM) at a central office (CO) to provide DSL communication services to a plurality of modems located at respective customer-premises. In general, a CO DSL modem receives broadband service content from, for example, a backbone server and forms a digital downstream DSL signal to be transmitted to a customer-premises equipment (CPE) DSL modem. Likewise, the CO DSL modem receives an upstream DSL signal from the CPE DSL modem and provides the data transported in the upstream DSL signal to the backbone server.

### BRIEF DESCRIPTION OF THE DRAWINGS

FIG. 1 is a schematic illustration of an example digital subscriber line (DSL) communication system constructed in accordance with the teachings of the disclosure.

FIG. 2 illustrates an example manner of implementing the example DSL access multiplexer (DSLAM) of FIG. 1.

FIGS. 3 and 4 are schematic illustrations of example line termination modules that may be used in the example DSLAM of FIG. 2.

FIG. 5 is a schematic illustration of an example common equipment module that may be used in the example DSLAM of FIG. 2.

FIG. 6 is a flowchart representative of example machine accessible instructions that may be carried out by, for example, a processor to implement either or both of the example element management systems of FIGS. 1 and 5.

FIG. 7 is a schematic illustration of an example processor platform that may be used and/or programmed to execute the example machine accessible instructions of FIG. 6 to implement either or both of the example element management systems of FIGS. 1 and 5.

### DETAILED DESCRIPTION

Methods and apparatus to test a central office (CO) digital subscriber line (DSL) modem are disclosed. A disclosed example line termination module for a DSL access multiplexer (DSLAM) includes a printed circuit board, a plurality of DSL terminal unit-central (DTU-C) modems implemented on the printed circuit board, a DSL terminal unit-remote (DTU-R) modem implemented on the printed circuit board to test the DTU-C modems, and a switch implemented on the printed circuit board to selectively couple the DTU-R modem to a tested one of the DTU-C modems or to a subscriber line.

A disclosed example DSLAM includes a housing, a line termination module disposed inside the housing, and comprising a plurality of DTU-C modems, a DTU-R modem disposed inside the housing, a switch disposed inside the housing to selectively couple the DTU-R modem to a tested one of the DTU-C modems within the housing or to a subscriber line, wherein the switch is to communicatively couple the DTU-R modem to the tested one of the DTU-C modem via a communication path disposed within the DSLAM, an element management system (EMS) to manage the line termination module and to control the DTU-R modem.

A disclosed example method to test a CO DSL modem of a DSLAM includes controlling a switch disposed inside the DSLAM to selectively couple the CO DSL modem to a test modem disposed inside the DSLAM, the CO DSL modem to be communicatively coupled to the test modem via a communication path disposed entirely within the DSLAM, initiating a test of the CO DSL modem by the test modem, and obtaining a test result from at least one of the CO DSL modem or the test modem.

While methods and apparatus to test a CO DSL modem in a DSL communication system are described herein, the example methods and apparatus may, additionally or alternatively, be used to test other types of equipment for other types of communication systems. Other example systems include, but are not limited to, those associated with public switched telephone network (PSTN) systems, public land mobile network (PLMN) systems (e.g., cellular), wireless distribution systems, wired or cable distribution systems, coaxial cable distribution systems, Ultra High Frequency (UHF)/Very High Frequency (VHF) radio frequency systems, satellite or other extra-terrestrial systems, cellular distribution systems, power-line broadcast systems, fiber optic networks, passive optical network (PON) systems, and/or any combination and/or hybrid of these devices, systems and/or networks.

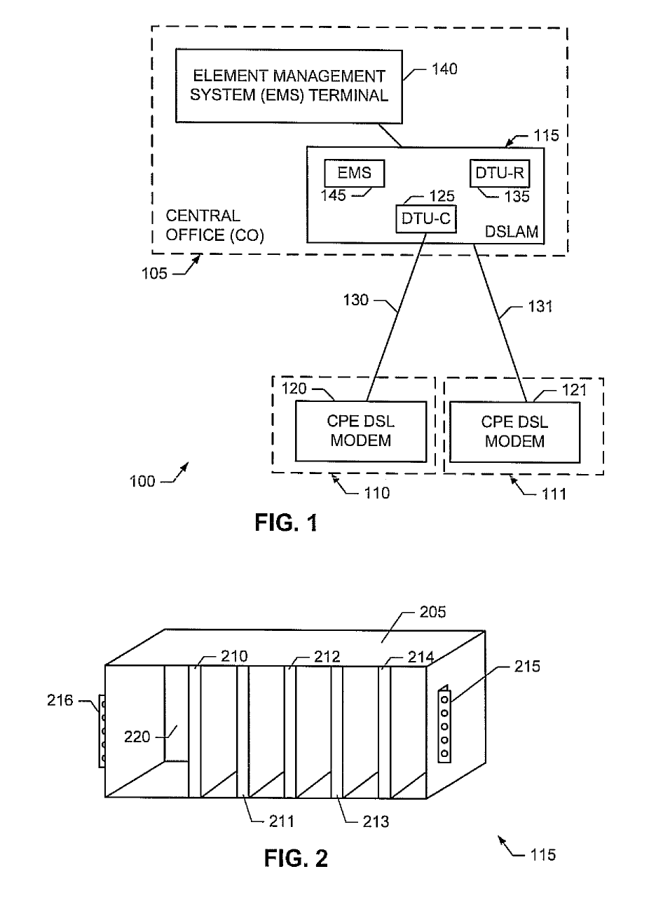

FIG. 1 illustrates an example DSL communication system 100 in which a CO 105 provides data and/or communication services (e.g., telephone services, Internet services, data services, messaging services, instant messaging services, electronic mail (email) services, chat services, video services, audio services, gaming services, etc.) to one or more customer-premises locations, two of which are designated at reference numerals 110 and 111. To provide DSL communication services to the customer-premises locations 110 and 111, the example CO 105 of FIG. 1 includes any number and/or type(s) of DSLAMs (one of which is designated at reference numeral 115), and the example customer-premises locations 110 and 111 include any type(s) of customer-premises equipment (CPE), such as CPE DSL modems 120 and 121. The example DSLAMs 115 and 116 of FIG. 1 include and/or implement one or more CO DSL modems (one of which is designated at reference numeral 125) for respective ones of the customer-premises locations 110 and 111.

The example DSLAM 115, the example CO DSL modem 125, and/or the example CPE DSL modems 120 and 121 of FIG. 1 may be implemented, for example, in accordance with the International Telecommunications Union-Telecommunications Sector (ITU-T) G.993.x family of standards for very high-speed DSL (VDSL), and/or the ITU-T G.992.x family of standards for asymmetric DSL (ADSL). For example, the example CO DSL modem 125 may implement an ADSL termination unit-central (ATU-C) modem, a VDSL termination unit-central (VTU-C) modem and/or, more generally, a DTU-C modem. Likewise, each of the example CPE DSL modems 120 and 121 may implement an ADSL termination unit-remote (ATU-R) modem, a VDSL termination unit-central (VTU-R) modem and/or, more generally, a DTU-R modem. As used herein, the term “DTU-C modem” refers to any type of DSL modem implemented in accordance with any past, present and/or future standard, recommendation and/or specification, and that is normally intended and/or designed for use at a CO location, such as the example CO 105. Likewise, the term “DTU-R modem,” as used herein, refers to any type of DSL modem implemented in accordance with any past, present and/or future standard, recommendation and/or specification, and that is normally intended and/or designed for use at a customer-premises location, such as the example customer-premises locations 110 and 111. Based on their intended use location, a DTU-C modem may differ from a DTU-R modem in any number of ways. For example, an ADSL based DTU-C transmits a signal having frequencies between 138 thousand cycles per second (kHz) and 1.1 million cycles per second (MHz), while an ADSL based DTU-R transmits a signal having frequencies between 26 kHz and 138 kHz.

In the illustrated example DSL communication system 100 of FIG. 1, the DSLAM 115 provides DSL services to the CPE DSL modems 120 and 121 via respective subscriber lines 130 and 131. Subscriber lines are sometimes also referred to in the industry as “wire-pairs”, “subscriber loops” and/or “loops.” While throughout this disclosure reference is made to the example subscriber lines 130 and/or 131 of FIG. 1, a subscriber line (e.g., any of the example subscriber lines 130 and 131) used to provide a DSL service to a customer-premises location (e.g., any of the locations 110 and 111) may include and/or be constructed from one or more segments of twisted-pair telephone wire (e.g., a combination of a feeder one (F1) cable, a feeder two (F2) cable, a distribution cable, a drop cable, and/or customer-premises wiring), terminals and/or distributions points (e.g., a serving area interface (SAI), a serving terminal, a vault and/or a pedestal). Such segments of twisted-pair telephone wire may be spliced and/or connected end-to-end, and/or may be connected at only one end thereby creating one or more bridged-taps. Regardless of the number, type(s), gauge(s) and/or topology of twisted-pair telephone wires used to construct the example subscriber lines 130 and 131, they will be referred to herein in the singular form, but it will be understood that the term “subscriber line” may refer to one or more twisted-pair telephone wire segments and may include one or more bridged taps.

In traditional DSL communication systems, a DTU-C modem is tested by communicatively coupling CO test equipment to a test access port of a DSLAM, and accessing a first user interface implemented by the DSLAM to communicatively couple the CO DSL modem to the test access port. Therefore, a second user interface provided by the CO test equipment is used to initiate the test of the CO DSL modem. Such CO test equipment is commonly referred to in the industry as an “external test head,” and implements, among other things, a DTU-R modem. When the DTU-C modem is communicatively coupled to the external test head, the DTU-R modem implemented by the external test head tests the DTU-C modem. In practice, the use of such CO test equipment by service providers has several drawbacks. First, another piece of equipment (i.e., the test head) must be purchased, engineered, installed, provisioned, configured and/or maintained. Such efforts must be expended in addition to any similar efforts that must be expended to provide services via the DSLAM. Second, as mentioned above, the use of such a test head requires that the service provider and/or service technician use and/or support user interfaces to both the test head and the DSLAM. Such dual user interfaces require that technicians be trained in using both user interfaces, and also require that service terminals be communicatively coupled to both the test head and the DSLAM. Some example test heads are manufactured in a standalone form factor, a portable form factor, a rack mounted form factor and/or a form factor that allows them to be semi-integrated into a DSLAM. For instance, they may be implemented on a printed circuit board (PCB) card that may be inserted into a shelf-based DSLAM. However, such so-called “integrated test heads” still require that an external cable be installed between a DSLAM test access port and the integrated test head, and still require the use of dual user interfaces to test a DTU-C modem. Moreover, such integrated test heads consume valuable space (e.g., slots) within a DSLAM that could otherwise be used to provide DSL services to subscribers.

In contrast, the methods and apparatus described herein fully integrate test capabilities into the example DSLAM 115 of FIG. 1 to overcome at least these deficiencies. In particular, one or more DTU-R modems (one of which is designated at reference numeral 135) are implemented by and/or within the example DSLAM 115 of FIG. 1 to facilitate testing of the example DTU-C modem 125 and/or any other DTU-C modems implemented by and/or within the DSLAM 115. Any of the DTU-C modems of the DSLAM 115 may be selectively coupled to the DTU-R modem 135 via an internal communication path that is disposed inside and/or within the DSLAM 115. Example integral communication paths include, but are not limited to, a signal trace of a printed circuit board, a signal trace of a backplane of the DSLAM 115, and a physical and/or logical portion of communication and/or interconnection bus of the DSLAM 115. Example manners of implementing the example DSLAM 115 of FIG. 1 are described below in connection with FIGS. 2-5.

To allow, among other things, a DTU-C modem 125 to be tested via a single user interface, and/or without manual equipment setup and/or manual cabling by a technician, the example DSL communication system 100 of FIG. 1 includes an EMS terminal 140 and the example DSLAM 115 includes an EMS 145. Via the example EMS terminal 140 of FIG. 1, a user can configure, provision, monitor, trouble shoot and/or test DSL services provided via the example DSLAM 115. For instance, the example EMS 145 may present one or more graphical user interfaces at the EMS terminal 140 that allow the user to view operating statistics, to view diagnostic information and/or to request that a particular DTU-C modem be tested. When, for example, the user requests diagnostic information for the example DTU-C modem 125, the example EMS 145 of FIG. 1 configures the DSLAM 115 to communicatively couple the DTU-C modem 125 to the example DTU-R modem 135 rather than to the subscriber line 130. The example EMS 145 then instructs the DTU-C modem 125 and the DTU-R modem 135 to test the DTU-C modem 125 by, for example, attempting to establish a DSL communication path between the DTU-C modem 125 and the DTU-R modem 135. After completion of the test, the DTU-C modem 125 and/or the DTU-R modem 135 report one or more test results to the EMS 145. Example test results include, but are not limited to, whether a DSL communication path was successfully established, and an achievable data rate. In some examples, the EMS 145 queries the DTU-C modem 125 and/or the DTU-R modem 135 for the test result(s). The example EMS 145 then reports the test result(s) along with possibly other diagnostic data (e.g., historical performance data) to the user via a graphical user interface at the EMS terminal 140. The example EMS 145 also then configures the DSLAM 115 to communicatively couple the DTU-C modem 125 to the subscriber line 130 such that DSL services may again be provided via the subscriber line 130 to the customer-premises location 110.

While in the illustrated example of FIG. 1, the example DSLAM 115, example EMS terminal 140 and the example EMS 145 are illustrated in connection with the example CO 105, one or more of the DSLAM 115, the EMS terminal 140 and/or the EMS 145 may be located and/or implemented separately from the CO 105. For example, the EMS terminal 140 may be located and/or implemented at a customer service location (not shown), which is communicatively coupled to the EMS 145 and/or, more generally, the DSLAM 115 at the CO 105. Additionally or alternatively, the example EMS 145 may be partially implemented within the example DSLAM 115 and partially implemented in an access management server implemented and/or located at the CO 105, at another CO and/or at a customer service location. Further any number of DSLAMs may be implemented and/or located at a CO. Moreover, the DSLAM 115 may be implemented and/or located at a remote terminal (not shown), which is communicatively coupled to the EMS terminal 140 via an AMS server at a CO (e.g., the example CO 105).

FIG. 2 illustrates an example manner of implementing the example DSLAM 115 of FIG. 1. The example DSLAM 115 of FIG. 2 has a shelf-based form factor that includes a housing 205 having a plurality of slots into which respective ones of a plurality of modules and/or cards 210-214 may the inserted. To allow the housing 205 to be mounted in a rack of equipment, the example housing 205 of FIG. 2 include brackets 215 and 216.

When a module 210-214 is fully inserted into a slot of the example housing 205 of FIG. 1, the module 210-214 becomes electrically and/or communicatively coupled to other inserted modules 210-214 via a backplane 220. The example backplane 220 of FIG. 2 includes a plurality of communication buses, signal traces, and/or communication interconnects to facilitate electrical and/or communicative coupling between the modules 210-214, and/or between the modules 210-214 and a power supply module (not shown). It will be understood that couplings between the modules 210-214 via the example backplane 220 are integral couplings of the DSLAM 115 (i.e., internal to the DSLAM) and, thus, do not require any external cabling and/or wiring. In some examples, a power supply module is implemented as one of the modules 210-214.

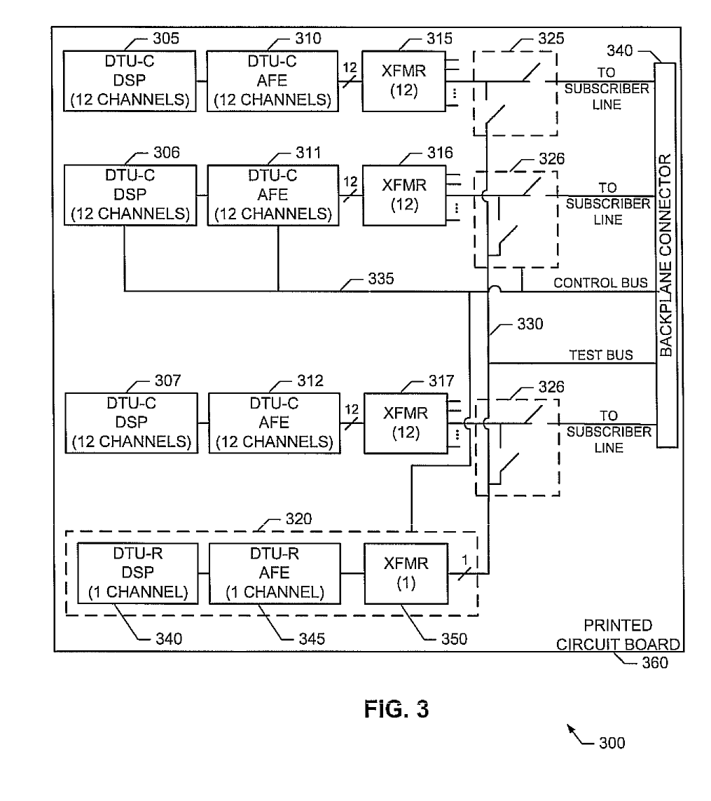

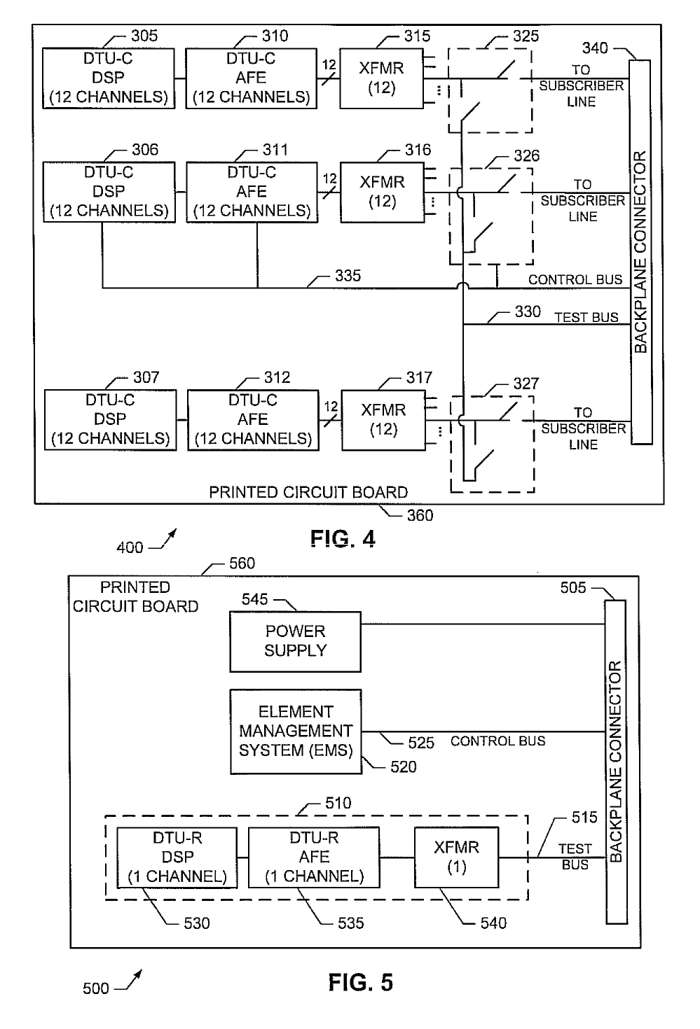

An example module 210-214 that implements a plurality of DTU-C modems and a DTU-R modem capable to test any or all of the DTU-C modems implemented by the example module 210-214 and/or any or all of the DTU-C modems implemented elsewhere in a DSLAM (e.g., on another module 210-214) is described below in connection with FIG. 3. An example module 210-214 that implements a plurality of DTU-C modems and includes one or more switches to selectively couple any of the DTU-C modems, via the example backplane 220, to a DTU-R implemented elsewhere within a DSLAM 115 is described below in connection with FIG. 4. An example module 210-214 that implements, among other things, an EMS and a DTU-R that may be communicatively coupled via the example backplane 220 to a DTU-C implemented elsewhere within the DSLAM 115 is described below in connection with FIG. 5.

While an example manner of implementing the example DSLAM 115 of FIG. 1 has been illustrated in FIG. 2, a DSLAM may be implemented using any form factor. For example, a DSLAM may be implemented as a standalone and/or self-contained box and/or housing containing a motherboard that implements common equipment functions (e.g., the EMS 145, a DTU-R 135, a power supply, etc.), and one or more line termination modules (e.g., configured as daughter cards that may be plugged into the motherboard) that each implement one or more DTU-C modems. In such an example, the DTU-C modems may be selectively coupled to the DTU-R via a communication path that is formed integral and internal to the DSLAM by the connectors that coupled the daughter board(s) to the motherboard. Such a form factor may be suitable for deployment in, for example, a communication vault, a basement of an apartment building, an office building, a pedestal, a wiring cabinet and/or a remote terminal.

FIG. 3 is a schematic illustration of an example line termination module 300 that may be used to implement any or all of the example modules 210-214 of FIG. 2. In general, the example line termination module 300 of FIG. 3 implements a plurality of DTU-C modems and a DTU-R modem capable to test any or all of the DTU-C modems implemented by the line termination module 300. The example line termination module 300 of FIG. 3 is implemented by one or more printed circuit boards onto which the components of the line termination module 300 are soldered and/or otherwise affixed.

To implement a plurality of DTU-C modems, the example line termination module 300 of FIG. 3 includes one or more digital signal processors (DSPs) (three of which are designated at reference numerals 305-307), one or more analog front ends (AFEs) (three of which are designated at reference numerals 310-312) and one or more transformer blocks (three of which are designated at reference numerals 315-317). Together, a combination comprising one of the DSPs 305-307, one of the AFEs 310-312 and one of the transformer blocks 315-317 implements a set of DTU-C modems. For example, the example DSP 305, the example AFE 310 and the example transformer block 315 of FIG. 3 implement twelve DTU-C modems in accordance with any past, present and/or future standard and/or specification, such as the ITU-T G.993.x and/or the ITU-T G.992.x families of standards.

The example DSPs 305-307 of FIG. 3 perform buffering, framing, de-framing, error correction encoding, error correction decoding, constellation encoding, and/or constellation decoding in accordance with any past, present and/or future standard and/or specification (e.g. the ITU-T G.992x and/or the G.993x families of standards). Each of the example AFEs 310-312 includes circuits, modules, devices and/or components (e.g., filters, digital-to-analog converters, and/or amplifiers) to process digital signals generated by the example DSPs 305-307 into analog signals suitable for transmission on a subscriber line. The example AFEs 310-312 likewise includes circuits, modules, devices and/or components (e.g., filters, analog-to-digital converters, and/or amplifiers) to process analog signals received via a corresponding transformer block 315-317 into digital signals suitable for processing by a corresponding one of the example DSPs 305-307. Each of the example transformer modules 315-317 of FIG. 3 perform, among other things, a 4-wire to 2-wire hybrid, amplification, and/or isolation and protection functions (e.g., against environmental factors such as lightning, short circuits, ground faults, power induction, etc.).

To test any of the DTU-C modems implemented by the DSPs 305-307, the AFEs 310-312 and the example transformer blocks 315-317, the example line termination module 300 of FIG. 3 includes a DTU-R modem 320 and a plurality of switches (three of which are designated at reference numerals 325-327). Each of the example switches 325-327 of FIG. 3 is associated with a particular DTU-C modem and a particular subscriber line (e.g., the example subscriber line 130 of FIG. 1). While for ease of understanding, only three switches 325-327 are illustrated in FIG. 3, it will be understood that each DTU-C modem implemented by the example line termination module 300 may have an associated switch. However, in some examples only one DTU-C modem of a particular combination of DSP 305-307, AFE 310-312 and transformer block 315 has an associated switch.

The example switches 325-327 of FIG. 3 are selectively configurable to couple a particular DTU-C modem to its associated subscriber line or to a test bus 330. As illustrated in FIG. 3, the test bus 330 is communicatively coupled to the DTU-R modem 320. By configuring a particular switch 325-327 to communicatively couple a corresponding DTU-C modem to the example test bus 330, the corresponding DTU-C modem may be tested by the example DTU-R modem 320 via the test bus 330. That is, the DTU-R modem 320 and the DTU-C modem being tested may be configured and/or directed to attempt to establish a DSL communication path via the test bus 330. Such testing may be performed to confirm the proper functioning of the DTU-C modem. Because a subscriber line (e.g., either of the example subscriber lines 130-131 of FIG. 1) is comprised of two conductors (i.e., wires) each of the example switches 325-327 is configured in a dual-pole topology, and the test-bus 330 comprises two signal traces of the line termination module 300. An example switch 325-327 comprises a pair relays arranged to implement a dual-pole dual-throw switch.

To control the operation of the DTU-C modems, the example switches 325-327 and/or the example DTU-R modem 320, the example line termination module 300 of FIG. 3 includes a control bus 335. While for ease of illustration the example control bus 335 is only shown as controlling one of the DSPs 305-307, one of the AFEs 310-312 and one of the switches 325-327, the control bus 335 may be used to control any or all of the DSPs 305-307, the AFEs 310-312 and/or the switches 325-327. In general, an EMS (e.g., the example EMS 145 of FIG. 1) controls and/or directs the operation of the line termination module 300 via the control bus 335. For example, the example control bus 335 may be used by the EMS to disable a particular DTU-C modem that is to be tested, configure its corresponding switch 325-327 to couple the DTU-C modem to the test bus 330, configure the DTU-C modem and the DTU-R modem 320 to test the DTU-C modem, obtain test results from the DTU-C modem and/or the DTU-R modem 320, reconfigure the switch 325-327 to couple the DTU-C modem to its associated subscriber line, and re-enable the DTU-C modem. Any number and/or type(s) of control signals, protocols and/or data formats may be used to implement the example control bus 335.

To communicatively couple the example line termination module 300 of FIG. 3 to other portions of a DSLAM (e.g., the example DSLAM 115 of FIG. 2), the example line termination module 300 includes a backplane connector 340. The example backplane connector 340 of FIG. 3 comprises a multi-conductor connector that allows multiple signal traces of the line termination module 300 to be electrically coupled to a backplane (e.g., the example backplane 220) when the connector 340 is fully inserted and/or mechanically coupled to a mating connector of the backplane. In the illustrated example of FIG. 3, subscriber lines are coupled to the line termination module 300 via the backplane connector 340, however, subscriber lines may be coupled to the line termination module 300 is other fashions.

The example DTU-R modem 320 of FIG. 3 includes a DSP 340, an AFE 345 and a transformer block 350. In contrast to DTU-C modems implemented by the DSPs 305-307, the AFEs 310-312, the transformer blocks 315-317, the example DSP 340, the example AFE 345 and the example transformer block 350 are configured to implement a DTU-R modem that would normally be used at a customer-premises location (e.g., any of the example locations 110-111 of FIG. 1) rather than at a CO (e.g., the example CO 105). Because the printed circuit board area required to implement the example DTU-R modem 320 is minimal, the DTU-R modem 320 is preferably implemented without a reduction in the number of DTU-C modems that may be implemented by the line termination module 300.

The example DSP 340 of FIG. 3 performs buffering, framing, de-framing, error correction encoding, error correction decoding, constellation encoding, and/or constellation decoding in accordance with any past, present and/or future standard and/or specification (e.g. the ITU-T G.992x and/or the G.993x families of standards). The example AFE 345 includes circuits, modules, devices and/or components (e.g., filters, digital-to-analog converters, and/or amplifiers) to process digital signals generated by the example DSP 340 into analog signals suitable for transmission on a subscriber line. The example AFE 345 likewise includes circuits, modules, devices and/or components (e.g., filters, analog-to-digital converters, and/or amplifiers) to process analog signals received via the transformer block 350 into digital signals suitable for processing by the example DSP 340. The example transformer module 350 of FIG. 3 performs among other things, a 4-wire to 2-wire hybrid, amplification, and/or isolation and protection functions (e.g., against environmental factors such as lightning, short circuits, ground faults, power induction, etc.).

While the example DTU-R modem 320 of FIG. 3 is implemented separately from the example DTU-C modems of FIG. 3, the DTU-R modem 320 may, alternatively, be implemented by any of the example DSPs 305-307, the example AFEs 310-312 and the example transformer blocks 315-317. For example, a particular combination of DSP 305-307, AFE 310-312 and transformer block 315-317 could be selectively configured to implement the DTU-R modem 320 instead of one of the DTU-C modems implemented by the combination.

The example DSPs 305-307, 340, the example AFEs 310-312, 320, the example transformer blocks 315-317, 350, the example switches 325-326, the example control bus 325, the example test bus 330 and the example backplane connector 340 of FIG. 3 are mounted to and/or implemented on any number and/or type(s) of printed circuit boards, one of which is designated at reference numeral 360.

FIG. 4 is a schematic illustration of an example line termination module 400 that may be used to implement any or all of the example modules 210-214 of FIG. 2. In general, the example line termination module 400 of FIG. 4 implements a plurality of DTU-C modems and includes one or more switches to selectively couple any of the DTU-C modems, via a backplane connector, to a DTU-R implemented elsewhere within a DSLAM. Portions of the example line termination module 400 of FIG. 4 are identical to those discussed above in connection with FIG. 3 and, thus, the descriptions of those portions are not repeated here. Instead, identical elements are illustrated with identical reference numerals in FIGS. 3 and 4, and the interested reader is referred back to the descriptions presented above in connection with FIG. 3 for a complete description of those like-numbered elements.

The example line termination module 400 of FIG. 4 is similar to the example line termination module 300 of FIG. 3 except that it does not include the example DTU-R modem 320 of FIG. 3. Instead, the example test bus 330 of FIG. 4 is used to communicatively couple, via the backplane connector 340, a DTU-C modem that is to be tested to a DTU-R modem implemented elsewhere within the DSLAM (e.g., by the example common equipment module 500 FIG. 5. Additionally or alternatively, the DTU-R modem could, for example, be located in another line termination module 210-214 of the example DSLAM 115 of FIG. 2.

FIG. 5 is a schematic illustration of an example common equipment module 500 that may be used to implement any or all of the example modules 210-214 of FIG. 2. In general, the example common equipment module 500 of FIG. 5 implements an EMS 520 and a DTU-R 510 that may be communicatively coupled via a backplane connector 505 to a DTU-C implemented elsewhere within a DSLAM. To communicatively couple elements of the example common equipment module 500 of FIG. 5 to other portions of a DSLAM (e.g., to any of the example line termination modules 300, 400), the example common equipment module 500 includes a backplane connector 505. The example backplane connector 505 of FIG. 5 comprises a multi-conductor connector that allows multiple signal traces of the common equipment module 500 to be electrically coupled to a backplane (e.g., the example backplane 220) when the connector 505 is fully inserted and/or mechanically coupled to a mating connector of the backplane.

To test a DTU-C modem implemented elsewhere within a DSLAM (e.g., any of the DTU-C modems implemented by the example line termination modules 300, 400), the example common equipment module 500 includes a DTU-R modem 510 and a test bus 515. The example test bus 515 of FIG. 5 is communicatively coupled to the test bus(es) of other modules of the DSLAM (e.g., to the example test bus 330 of FIG. 3) via the backplane connector 505. As illustrated in FIG. 5, the example DTU-R modem 510 may be communicatively coupled to a DTU-C modem implemented elsewhere via the test bus 515 and the backplane connector 505. As described above, the particular DTU-C modem to which the example DTU-R modem 510 is coupled depends upon which switch 325-327 has been configured, by the EMS 520 via a control bus 525, to communicatively couple the DTU-C modem to the test bus of its respective line termination module. The example control bus 525 of FIG. 5 is communicatively coupled to the control bus(es) of other modules of the DSLAM (e.g., to the example control bus 335 of FIG. 3) via the backplane connector 505 to control the state of the switches (e.g., the example switches 325-327).

The example DTU-R modem 510 of FIG. 5 includes a DSP 530, an AFE 535 and a transformer block 540. The example DSP 530 of FIG. 5 performs buffering, framing, de-framing, error correction encoding, error correction decoding, constellation encoding, and/or constellation decoding in accordance with any past, present and/or future standard and/or specification (e.g. the ITU-T G.992x and/or the G.993x families of standards). The example AFE 535 of FIG. 5 includes circuits, modules, devices and/or components (e.g., filters, digital-to-analog converters, and/or amplifiers) to process digital signals generated by the example DSP 530 into analog signals suitable for transmission on a subscriber line. The example AFE 535 likewise includes circuits, modules, devices and/or components (e.g., filters, analog-to-digital converters, and/or amplifiers) to process analog signals received via the transformer block 540 into digital signals suitable for processing by the example DSP 530. The example transformer module 540 of FIG. 5 performs among other things, a 4-wire to 2-wire hybrid, amplification, and/or isolation and protection functions (e.g., against environmental factors such as lightning, short circuits, ground faults, power induction, etc.).

To control the operation of a DSLAM, the example common equipment module 500 of FIG. 5 includes the example EMS 520. Via an EMS terminal (e.g., the example EMS terminal 140 of FIG. 1) communicatively coupled to the EMS 520, a user can configure, provision, monitor, trouble shoot and/or test DSL services provided via the example DSLAM. For instance, the example EMS 520 may present one or more graphical user interfaces at the EMS terminal that allow the user to view operating statistics, to view diagnostic information and/or to request that a particular DTU-C modem be tested. When, for example, the user requests diagnostic information for a particular DTU-C modem, the example EMS 520 of FIG. 5 configures the corresponding switch of the line termination module that implements the DTU-C modem to communicatively couple the DTU-C modem to the example DTU-R modem 510 via the test bus 515. This configuration of the switch decouples the DTU-C modem from its associated subscriber line. The example EMS 520 then instructs the DTU-C modem and the DTU-R modem 510 to test the DTU-C modem by, for example, attempting to establish a DSL communication path between the DTU-C modem and the DTU-R modem 510. After completion of the test, the DTU-C modem and/or the DTU-R modem 510 report one or more test results to the EMS 520. Example test results include, but are not limited to, whether a DSL communication path was successfully established, and an achievable data rate. In some examples, the EMS 520 queries the DTU-C modem and/or the DTU-R modem 510 for the test result(s). The example EMS 520 then reports the test result(s) along with possibly other diagnostic data (e.g., historical performance data) to the user via a graphical user interface at the EMS terminal. The example EMS 520 also then configures the DSLAM to communicatively couple the DTU-C modem to its associated subscriber line such that DSL services may again be provided via the subscriber line to a customer-premises location.

To supply power, the example common equipment module 500 of FIG. 5 includes a power supply 545. The example power supply 545 of FIG. 5 provides power to the components of the common equipment module 500 and/or to other modules of the DSLAM via the example backplane module 505. For example, the power supply 545 of FIG. 5 provides a ground signal and −48 volt (V) direct current (DC) signal to the other modules of the DSLAM. The example power supply 545 of FIG. 5 may be implemented using any number and/or type(s) of devices and/or circuits.

The example backplane connector 505, the example DTU-R 510, the example test bus 515, the example EMS 520, the example control bus 525, the example DSP 530, the example AFE 535, the example transformer block 540, the example power supply 545 of FIG. 5 are mounted to and/or implemented on any number and/or type(s) of printed circuit boards, one of which is designated at reference numeral 560.

While example manners of implementing any or all of the example modules 210-214 of FIG. 1 have been illustrated in FIGS. 3-5, one or more of the elements, processes and/or devices illustrated in FIGS. 3, 4 and/or 5 may be combined, divided, re-arranged, omitted, eliminated and/or implemented in any other way. Further, the example DSPs 305-307, 340, 530, the example AFEs 310-312, 345, 535, the example transformer blocks 315-317, 350, 540, the example DTU-R modems 320, 510, the example switches 325-327, the test buses 330, 515, the control busses 335, 525, the example EMS 520 and/or, more generally, the example modules 300, 400 and/or 500 may be implemented by hardware, software, firmware and/or any combination of hardware, software and/or firmware. Thus, for example, any or all of the example DSPs 305-307, 340, 530, the example AFEs 310-312, 345, 535, the example transformer blocks 315-317, 350, 540, the example DTU-R modems 320, 510, the example switches 325-327, the test buses 330, 515, the control busses 335, 525, the example EMS 520 and/or, more generally, the example modules 300, 400 and/or 500 may be implemented by one or more circuit(s), programmable processor(s), application specific integrated circuit(s) (ASIC(s)), programmable logic device(s) (PLD(s)) and/or field programmable logic device(s) (FPLD(s)), etc. When any of the appended claims are read to cover a purely software implementation, at least one of the example DSPs 305-307, 340, 530, the example AFEs 310-312, 345, 535, the example transformer blocks 315-317, 350, 540, the example DTU-R modems 320, 510, the example switches 325-327, the test buses 330, 515, the control busses 335, 525, the example EMS 520 and/or, more generally, the example modules 300, 400 and/or 500 are hereby expressly defined to include a tangible medium such as a memory, a digital versatile disc (DVD), a compact disc (CD), etc. Further still, line termination module and/or a common equipment module may include one or more elements, processes and/or devices in addition to, or instead of, those illustrated in FIGS. 3-5, and/or may include more than one of any or all of the illustrated elements, processes and devices.

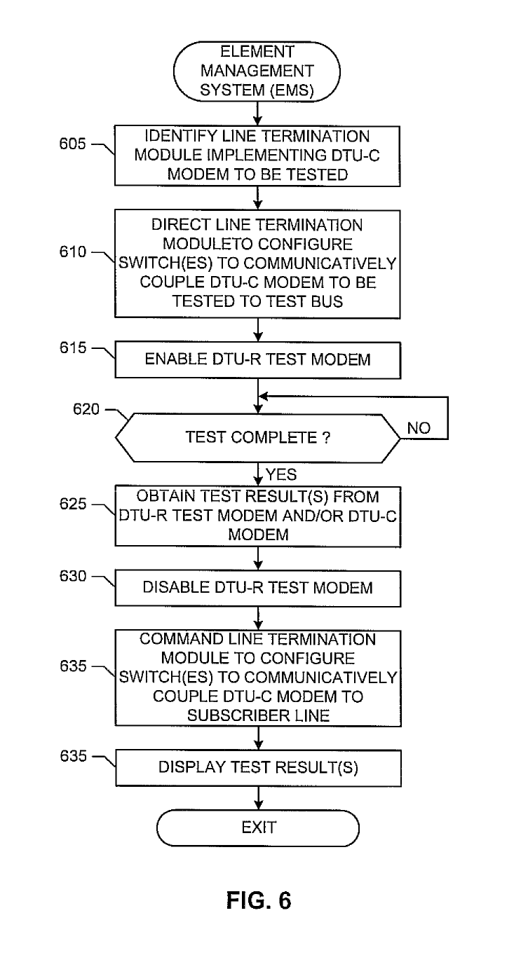

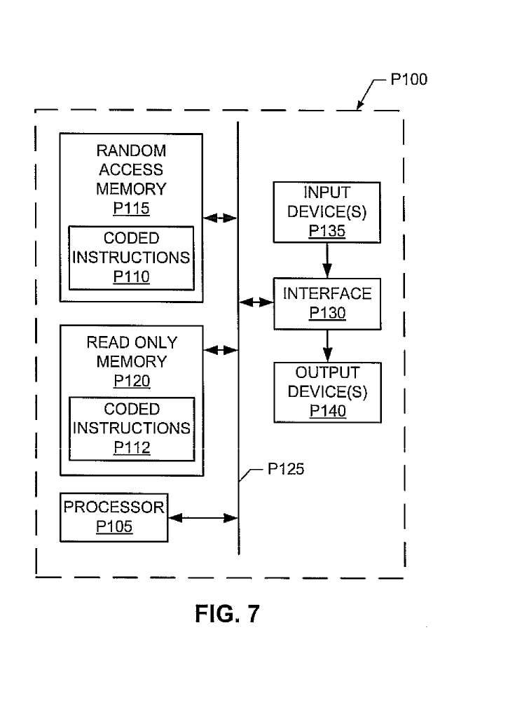

FIG. 6 is a flowchart representative of example machine accessible instructions that may be carried out to implement any or all of the example EMS 145 of FIG. 1 and/or the example EMS 520 of FIG. 5. The example machine accessible instructions of FIG. 6 may be carried out by a processor, a controller and/or any other suitable processing device. For example, the example machine accessible instructions of FIG. 6 may be embodied in coded instructions stored on a tangible medium such as a flash memory, a read-only memory (ROM) and/or random-access memory (RAM) associated with a processor (e.g., the example processor P105 discussed below in connection with FIG. 7). Alternatively, some or all of the example machine accessible instructions of FIG. 5 may be implemented using any combination(s) of circuit(s), ASIC(s), PLD(s), FPLD(s), discrete logic, hardware, firmware, etc. Also, some or all of the example machine accessible instructions of FIG. 6 may be implemented manually or as any combination of any of the foregoing techniques, for example, any combination of firmware, software, discrete logic and/or hardware. Further, although the example operations of FIG. 6 are described with reference to the flowchart of FIG. 6, many other methods of implementing the operations of FIG. 6 may be employed. For example, the order of execution of the blocks may be changed, and/or one or more of the blocks described may be changed, eliminated, sub-divided, or combined. Additionally, any or all of the example machine accessible instructions of FIG. 6 may be carried out sequentially and/or carried out in parallel by, for example, separate processing threads, processors, devices, discrete logic, circuits, etc.

The example machine accessible instructions of FIG. 6 begin when an EMS (e.g., either of the example EMS 145 of FIG. 1 and/or the example EMS 520 of FIG. 5) receives a request to test a particular DTU-C modem. The EMS identifies the line termination module that implements the DTU-C modem to be tested (block 605). The EMS controls the switch associated with the DTU-C modem (e.g., the example switch 325 of FIG. 3) to selectively couple the DTU-C modem to a test bus (e.g., the example test bus 330) (block 610).

The EMS enables and/or configures a DTU-R modem coupled to the test bus (e.g., the example DTU-R modem 320 of FIG. 3 and/or the example DTU-R modem 510 of FIG. 5) to test the DTU-C modem (block 615). The EMS waits for the DTU-R modem and the DTU-C to complete testing of the DTU-C modem (block 620).

When testing is complete (block 620), the EMS obtains one or more test results from the DTU-R modem and/or the DTU-C modem (block 625), and disables and/or reconfigures the DTU-R modem (block 630). The EMS then controls the switch associated with the DTU-C modem (e.g., the example switch 325 of FIG. 3) to selectively couple the DTU-C modem back to its associated subscriber line (block 635), and displays and/or presents the test result(s) (block 640). Control then exits from the example machine accessible instructions of FIG. 6.

FIG. 7 is a schematic diagram of an example processor platform P100 that may be used and/or programmed to implement all or a portion of any or all of the example DSPs 305-307, 340, 530, the example AFEs 310-312, 345, 535, the example transformer blocks 315-317, 350, 540, the example DTU-R modems 320, 510, the example switches 325-327, the test buses 330, 515, the control busses 335, 525, the example EMS 145, 520 of FIGS. 1-5. For example, the processor platform P100 can be implemented by one or more general purpose processors, processor cores, microcontrollers, etc.

The processor platform P100 of the example of FIG. 7 includes at least one general purpose programmable processor P105. The processor P105 executes coded instructions P110 and/or P112 present in main memory of the processor P105 (e.g., within a RAM P115 and/or a ROM P120). The processor P105 may be any type of processing unit, such as a processor core, a processor and/or a microcontroller. The processor P105 may execute, among other things, the example machine accessible instructions of FIG. 7 to implement the example methods and apparatus described herein.

The processor P105 is in communication with the main memory (including a ROM P120 and/or the RAM P115) via a bus P125. The RAM P115 may be implemented by dynamic random access memory (DRAM), synchronous dynamic random access memory (SDRAM), and/or any other type of RAM device, and ROM may be implemented by flash memory and/or any other desired type of memory device. Access to the memory P115 and the memory P120 may be controlled by a memory controller (not shown).

The processor platform P100 also includes an interface circuit P130. The interface circuit P130 may be implemented by any type of interface standard, such as an external memory interface, serial port, general purpose input/output, etc. One or more input devices P135 and one or more output devices P140 are connected to the interface circuit P130. The input devices P135 and/or output devices P140 may be used to, for example, implement the example control bus 335 of FIG. 3, the example control bus 525 of FIG. 5, and/or interfaces to the same.

Of course, the order, size, and proportions of the memory illustrated in the example systems may vary. Additionally, although this patent discloses example systems including, among other components, software or firmware executed on hardware, such systems are merely illustrative and should not be considered as limiting. For example, it is contemplated that any or all of these hardware and software components could be embodied exclusively in hardware, exclusively in software, exclusively in firmware or in some combination of hardware, firmware and/or software. Accordingly, the above described examples are not the only way to implement such systems.

At least some of the above described example methods and/or apparatus are implemented by one or more software and/or firmware programs running on a computer processor. However, dedicated hardware implementations including, but not limited to, an ASIC, programmable logic arrays and other hardware devices can likewise be constructed to implement some or all of the example methods and/or apparatus described herein, either in whole or in part. Furthermore, alternative software implementations including, but not limited to, distributed processing or component/object distributed processing, parallel processing, or virtual machine processing can also be constructed to implement the example methods and/or apparatus described herein.

It should also be noted that the example software and/or firmware implementations described herein are optionally stored on a tangible storage medium, such as: a magnetic medium (e.g., a disk or tape); a magneto-optical or optical medium such as a disk; or a solid state medium such as a memory card or other package that houses one or more read-only (non-volatile) memories, random access memories, or other re-writable (volatile) memories; or a signal containing computer instructions. A digital file attachment to e-mail or other self-contained information archive or set of archives is considered a distribution medium equivalent to a tangible storage medium. Accordingly, the example software and/or firmware described herein can be stored on a tangible storage medium or distribution medium such as those described above or equivalents and successor media.

To the extent the above specification describes example components and functions with reference to particular devices, standards and/or protocols, it is understood that the teachings of the invention are not limited to such devices, standards and/or protocols. Such systems are periodically superseded by faster or more efficient systems having the same general purpose. Accordingly, replacement devices, standards and/or protocols having the same general functions are equivalents which are intended to be included within the scope of the accompanying claims.

Although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

What is claimed is:

1. A line termination module for a digital subscriber line (DSL) access multiplexer (DSLAM), the line termination module comprising:
a printed circuit board;
a plurality of DSL terminal unit-central (DTU-C) modems implemented on the printed circuit board;
a DSL terminal unit-remote (DTU-R) modem implemented on the printed circuit board to test the DTU-C modems; and
a switch implemented on the printed circuit board to selectively couple the DTU-R modem to a tested one of the DTU-C modems or to a subscriber line.

2. A line termination module as defined in claim 1, wherein the DTU-R modem comprises at least one of an asymmetric DSL-remote modem or a very high-speed DSL-remote modem.

3. A line termination module as defined in claim 1, wherein the switch comprises:
a first relay to selectively couple a first trace of the printed circuit board to the DTU-R modem or a first subscriber line wire, the first trace communicatively coupled to the tested one of the DTU-C modems; and
a second relay to selectively couple a second trace of the printed circuit board to the DTU-R modem or a second subscriber line wire, the first trace communicatively coupled to the tested one of the DTU-C modems, and the first and second subscriber line wires forming a twisted-pair subscriber line.

4. A digital subscriber line (DSL) access multiplexer (DSLAM) comprising:
a housing;
a line termination module disposed inside the housing, and comprising a plurality of DSL terminal unit-central (DTU-C) modems;
a DSL terminal unit-remote (DTU-R) modem disposed inside the housing;
a switch disposed inside the housing to selectively couple the DTU-R modem to a tested one of the DTU-C modems within the housing or to a subscriber line, wherein the switch is to communicatively couple the DTU-R modem to the tested one of the DTU-C modem via a communication path disposed within the DSLAM; and
an element management system (EMS) to manage the line termination module and to control the DTU-R modem.

5. A DSLAM as defined in claim 4, wherein the line termination module comprises the DTU-R modem, the switch, and at least a portion of the communication path.

6. A DSLAM as defined in claim 4, further comprising a common equipment module comprising the DTU-R modem, the common equipment module communicatively coupled to the line termination module via the communication path.

7. A DSLAM as defined in claim 6, further comprising a backplane communicatively coupled to the line termination module, wherein the communication path comprises a trace of the backplane.

8. A DSLAM as defined in claim 4, wherein the EMS is to:
receive a test request;
selectively control the switch to couple the DTU-R modem to the tested one of the DTU-C modems;
obtain a test result from at least one of the DTU-R modem or the tested one of the DTU-C modems; and
output the test result.

9. A DSLAM as defined in claim 4, wherein the housing comprises a communication equipment shelf, and the line termination module comprises a printed circuit board having a form factor compatible with the communication equipment shelf.

10. A DSLAM as defined in claim 4, wherein the housing comprises a remote terminal housing.

11. A DSLAM as defined in claim 4, wherein the DTU-R modem comprises at least one of an asymmetric DSL-remote modem or a very high-speed DSL-remote modem.

12. A DSLAM as defined in claim 4, wherein the switch comprises:
a first relay to selectively couple a first wire communicatively coupled to the tested one of the DTU-C modems to a second wire of the communication path or to a first subscriber line wire, the first wire; and
a second relay to selectively couple a third wire communicatively coupled to the tested one of the DTU-C modems to a fourth wire of the communication path or to a second subscriber line wire, wherein the second and fourth wires of the communication path are communicatively coupled to the DTU-R modem, and the first and second subscriber line wires form a twisted-pair subscriber line.

13. A method to test a central office (CO) digital subscriber line (DSL) modem of a DSL access multiplexer (DSLAM), the method comprising:
controlling a switch disposed inside the DSLAM to selectively couple the CO DSL modem to a test modem disposed inside the DSLAM, the CO DSL modem to be communicatively coupled to the test modem via a communication path disposed entirely within the DSLAM;
initiating a test of the CO DSL modem by the test modem; and
obtaining a test result from at least one of the CO DSL modem or the test modem.

14. A method as defined in claim 13, further comprising controlling the switch to couple the CO DSL modem to a subscriber line upon completion of the test of the CO DSL modem.

15. A method as defined in claim 13, further comprising:
receiving a test request message to test the CO DSL modem;
identifying a line termination module housing the CO DSL modem and the switch; and
sending a response message comprising the test result.

16. A method as defined in claim 13, further comprising inserting a line termination module into the DSLAM, the line termination module comprising the CO DSL modem, the switch and the test modem.

17. A method as defined in claim 13, further comprising:
inserting a line termination module into a backplane of the DSLAM, the line termination module comprising the CO DSL modem and the switch; and
inserting a common equipment module into the backplane of the DSLAM, the common equipment module comprising the test modem and the element management system, the element management system to selectively configure the switch, the test modem communicatively coupled to the CO DSL modem and the switch via the backplane.

18. An article of manufacture storing machine readable instructions which, when executed, cause a machine to:
control a switch disposed inside a digital subscriber line (DSL) access multiplexer (DSLAM) to selectively couple a central office (CO) DSL modem to a test modem disposed inside the DSLAM, the CO DSL modem to be communicatively coupled to the test modem via a communication path disposed entirely within the DSLAM;
initiate a test of the CO DSL modem by the test modem; and
obtain a test result from at least one of the CO DSL modem or the test modem.

19. An article of manufacture as defined in claim 18, wherein the machine readable instructions, when executed, cause the machine to control the switch to couple the CO DSL modem to a subscriber line upon completion of the test of the CO DSL modem.

20. An article of manufacture as defined in claim 18, wherein the machine readable instructions, when executed, cause the machine to:
receive a test request message to test the CO DSL modem;
identify a line termination module housing the CO DSL modem and the switch; and
send a response message comprising the test result.
